(19) United States
(12) Patent Application Publication
(10) Pub. No.: US 2026/0234990 A1
(43) Pub. Date: Aug. 13, 2026

(54) ELECTRONIC PRIVACY SHADE

(71) Applicant: Ronald Muscosky, Penfield, NY (US)

(72) Inventor: Ronald Muscosky, Penfield, NY (US)

(21) Appl. No.: 19/251,793

(22) Filed: Jun. 27, 2025

Related U.S. Application Data
(60) Provisional application No. 63/756,362, filed on Feb. 10, 2025.

(51) Int. Cl. E06B 9/24

(52) U.S. Cl. CPC E06B 9/24; E06B 2009/247

(57) ABSTRACT

The present invention is a privacy shade, comprising: a frame, wherein the frame attached to a window frame; a power source integrated into the frame; an electronically controlled film secured to the frame and connected to the power source; and a controller module in communication with the electronically controlled film and the power source.

### CROSS-REFERENCE TO RELATED APPLICATIONS

This application is a continuation (and claims the benefit of priority under 35 USC 120) of U.S. provisional application No. 63/756,362 filed Feb. 10, 2025, now pending. The disclosure of the prior applications is considered part of (and is incorporated by reference in) the disclosure of this application.

### BACKGROUND OF THE INVENTION

The present invention relates to an electronic privacy shade, and more particularly to an electronic privacy shade for building windows, transport vehicles, divider walls, product/artwork unveilings, signage and the like where shading or visual privacy can be controlled by the end user or automatically using various surrounding inputs.

Methods of providing shading and visual privacy have traditionally consisted of devices such as a window curtain, window blind, window shade, divider wall, etc. that require manual positioning and adjustment based upon the location and amount of shading or visual privacy desired. In recent years, some of these devices have evolved to minimize manual intervention through the use of motors for adjusting the amount of shading and visual privacy, such as motorized curtains and blinds. However, moving mechanical parts and motorization introduce points of failure and reliability issues. Even more recently, electronic film and Smart Glass have been introduced to provide an electronic means of shading or visual privacy. Electronic film, a switchable opaque film, is adhered to an existing surface and wired to a power source, requiring skilled professional installation and the expense that accompanies it. Smart Glass takes this one step further by sandwiching electronic film between its layers of glass, but is expensive to manufacture and requires professional installation.

There are many examples of prior art for blinds, shades, electronic film and Smart Glass, where each has its own drawbacks. Some inventions require physical end user movement of the device to adjust the shading or privacy. Other inventions utilize mechanical/motorized movement of the device to adjust shading or privacy. Others require skilled installation by adhering electronic film to an existing transparent surface or utilize multiple layers of electronic film. Yet others require expensive manufacturing and installation.

Some prior art describes a window blind for privacy that includes slats made of transparent material having an embossed pattern and a printed pattern thereon sufficient to decrease the transparency of the slat and obscure visibility through the slats while maintaining a high degree of translucency. A lift cord is positioned outside of the slats, and the slats are constructed to close without exposing significant voids there through that are not overlapped by an adjacent slat. A valance is formed from slats and overlaps spaces that may occur above and below the head rail.

Some prior art describes an aircraft window shade that includes protective transparent window panels, a shade driven by an electric motor, an integral control panel, and support for remote operation. The shade uses dual sprocket drive for positive shade positioning, low wear, and low parts count. The moving shade element remains substantially flat, curving slightly during some phases of positioning. The apparatus replaces a conventional interior window panel and a manual shade with slight change in overall mechanism thickness and weight. Control electronics in the shade can accept a command from a cabin attendant's console to override the local setting and move the shade to a required position, such as fully open for takeoff. The shade supports use of two or more independent shades, each of which can be made of dimming (transparent), diffusing (translucent), or light blocking (opaque) material.

Some prior art describes an electronic window covering control system that automatically controls the position and orientation of a window covering. A window covering controller interfaces with a light intensity sensor, a temperature sensor, and an electronic window covering configured to raise and lower the covering and tilt the slats. The window covering controller sends sensor data to a local receiver and receives window covering commands from the local receiver. The local receiver interfaces with a hub device through a mesh network and sends the sensor data to the hub. The hub applies a rule set to make operation decisions based on sensor data and user preferences, and sends messages comprising commands to operate the window covering through the mesh network to the local receiver. The local receiver decodes the messages and passes the window covering commands to the window covering controller to automatically control the electronic window covering.

Some prior art describes an electronic curtain moving device. This device can comprise: a pulley operably connected to a motor, the pulley having a groove through which a cord of a curtain travels, wherein the pulley can move in clockwise and counter-clockwise directions; a head capable of movement from a first and a second position; Wherein movement of the pulley in the clockwise direction makes the head move to the first position and make contact with the cord, and movement of the pulley in the counter-clockwise direction makes the head move to the second position and make contact with the cord at a different location than contact at the first position.

Some prior art describes an automatic electronic window shading (tinting) system for houses and transport vehicles such as automobiles, RV's, trains, boats and the like, to provide shading for people to protect them from exposure to harmful direct sunlight, by providing the windows of said houses and transport vehicles with display elements and light (photocell/photovoltaic) sensors. The system comprises liquid crystal, electrochromic, suspended particle device (SPD), or NanoChromics display (NCD) element attached to a part of a transparent body (such as the windows) and a liquid crystal, electrochromic, suspended particle device (SPD), or NanoChromics display (NCD) controlling semiconductor element controlling the operation of the display element.

Some prior art describes an apparatus and method that includes, among other things, a transparent lighting source, a switchable opaque film bonded to the transparent lighting source to provide a vehicle component, and an electrical connection that connects to the transparent lighting source and the switchable opaque film such that the switchable opaque film is electrically controlled to switch between an opaque state and a transparent state. A control unit independently controls the switchable opaque film and the transparent lighting source based on a predetermined application for the vehicle component. In a further non-limiting embodiment of the foregoing apparatus, the switchable opaque film and the transparent lighting source are laminated together to form a layered structure. In a further non-limiting embodiment of any of the foregoing apparatus, the layered structure is integrated between two layers of glass.

Some prior art describes an electronic venetian blind including a first transparent conductive film layer; a plurality of unit electrochromic layers stacked on the first transparent conductive film layer, arranged separated from each other; and a plurality of second transparent conductive film layers each stacked on the plurality of unit electrochromic layers and independently applying current thereto. Prior art is specific to the manufacturing of the electronic film layering to achieve a venetian blind effect. In an embodiment, the film is sandwiched between two layers of glass.

Some prior art describes a switchable projection window that comprises a first layer including a liquid crystal microdroplet (LCMD) display switchable between transparent and opaque states in response to a change in an applied electrical voltage and a second layer coupled to the first layer. The second layer is changeable between a light transmitting configuration and a light blocking configuration by physically or mechanically moving the layer out of the light path.

Each of the prior art examples have various drawbacks, and therefore, there is a need for a privacy shade to decrease one or more problems with one or more of the existing devices and/or methods for controlling shading or privacy.

### SUMMARY

In a first embodiment, the present invention is a privacy shade, comprising: a frame; and an electronically controlled film secured within the frame.

In a second embodiment, the present invention is a privacy shade, comprising: a housing; at least two electronically controlled films integrated with the housing; and an integrated controller module in communication with the at least two electronically controlled films.

In a third embodiment, the present invention is a privacy shade, comprising: an internal or external power source; an electronically controlled film retracted or lowered from a shade tube; an electronically controlled film attached to the frame and connected to the power source; and a controller module in communication with the electronically controlled film and the power source.

### BRIEF DESCRIPTION OF THE DRAWINGS

FIG. 1 depicts an electronic privacy shade mounted on a window casing, in accordance with one embodiment of the present invention.

FIG. 2 depicts the electronic privacy shade, in accordance with one embodiment of the present invention.

FIG. 3 depicts the electronic privacy shade depicting clips for mounting, in accordance with one embodiment of the present invention.

FIG. 4 depicts the electronic privacy shade depicting hook and loop style fasteners, in accordance with one embodiment of the present invention.

FIG. 5 depicts the electronic privacy shade depicting magnet fasteners, in accordance with one embodiment of the present invention.

FIG. 6 depicts the electronic privacy shade depicting a manual switch, in accordance with one embodiment of the present invention.

FIG. 7 depicts the electronic privacy shade depicting a variable voltage regulator, in accordance with one embodiment of the present invention.

FIG. 8 depicts the electronic privacy shade depicting a remote control, in accordance with one embodiment of the present invention.

FIG. 9 depicts the electronic privacy shade depicting an external controller module, in accordance with one embodiment of the present invention.

FIG. 10 depicts the electronic privacy shade and the external controller module, in accordance with another embodiment of the present invention.

FIG. 11 depicts the electronic privacy shade depicting multiple electronic films, in accordance with one embodiment of the present invention.

FIG. 12 depicts the electronic privacy shade with a rechargeable battery power source, in accordance with one embodiment of the present invention.

FIG. 13 depicts the electronic privacy shade with solar panels, in accordance with one embodiment of the present invention.

FIG. 14 depicts the electronic privacy shade with integrated lighting, in accordance with one embodiment of the present invention.

FIG. 15 depicts the electronic privacy shade with various sensors, in accordance with one embodiment of the present invention.

FIG. 16 depicts the electronic privacy shade, in accordance with another embodiment of the present invention.

### DETAILED DESCRIPTION OF THE INVENTION

The present invention provides a device that is an electronic privacy shade that can be easily installed and controlled by the end user at a location where visual privacy or shading is needed. Some examples include, but not limited to, building windows, transport vehicles, divider walls, product/artwork unveilings, signage, and the like.

The device is an electronic privacy shade for building windows, transport vehicles, divider walls, product/artwork unveilings, signage and the like to provide shading or visual privacy where needed in a cost effective and easy to install manner. The invention comprises electronic film, such as but not limited to, Polymer Dispersed Liquid Crystal (PDLC), Suspended Particle Device (SPD), Cholesteric Liquid Crystal (CLC), NanoChromics Display (NCD) or Organic Electroluminescent Display (OELD), surrounded by and supported by a frame that allows the invention to be hung from or mounted at any location. In another configuration the electronic film can be retracted around or lowered from a shade tube with a weighted hem bar at the bottom for stability, and mounted similar to a traditional roller shade. Its transparency can be controlled manually by a manual switch or an adjustable switch or remotely using a controller module coupled with a selection of modern devices such as computing device, remote control, smart phone, tablet, computer, smart watch, voice assistant or the like. The invention can be powered from a standard power outlet, batteries or other sources of renewable energy. Lighting can be incorporated to match the décor in which it is installed or to provide additional ambiance. Sensors, cameras and artificial intelligence (AI) can be utilized to intelligently adjust the shading or visual privacy based upon detected and learned conditions and triggers.

The following paragraphs and figures are more detailed descriptions of various embodiments of the invention described herein. In particular, the various embodiments disclosed herein describe an electronic privacy shade. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of the ordinary skills in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates, which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

The invention provides the advantages of being inexpensively mass produced when compared to Smart Glass that requires complex and expensive manufacturing and installation processes. In addition, the invention does not require mechanical moving parts and/or motors that are prone to failure to achieve the desired privacy, so is reliable when compared to existing smart blinds that utilize such motors and moving parts to achieve varying amounts of shading and privacy.

The invention can be installed at the desired location by the end user without the need for specialized labor, similar to hanging a picture. In one embodiment, the invention can be hung in place using hooks. In another embodiment, clips or brackets are used to secure the invention in place. In another embodiment, hook and loop style fasteners, various types of tape, or other types of fasteners of can be used to secure the invention in place. In yet another embodiment, magnets, magnetic tape or other similar methods can be used to secure the invention in place. This not only allows the invention to be quickly and easily installed by the end user, but also quickly and easily removed and reinstalled when needed (e.g. window cleaning or window opening) without special tools or skills.

The invention requires power to change the transparency of the electronic film, where varying the power applied will vary the amount of transparency. In one embodiment, this power can be sourced from a standard AC wall outlet for compatibility with existing building infrastructure. In another embodiment, power can be provided by rechargeable or disposable external DC batteries, such as by not limited to a transport vehicle battery. In yet another embodiment, power can be provided by rechargeable or disposable batteries enclosed in the frame. In yet another embodiment, power sources include, but are not limited to, renewable energy such as solar panels that can be mounted externally or on the invention frame. Depending upon the power source and the power required by the electronic film, the source voltage can be run through an inverter and/or stepped up or down as needed.

The invention allows the user to adjust the amount of transparency. In one embodiment, the transparency can be turned on or off using a simple wired switch. In another embodiment, the transparency can be adjusted using a variable voltage regulator. In yet another embodiment, the transparency can be adjusted remotely using Wi-Fi, Bluetooth or similar communication protocol in conjunction with a controller module and computing device, manual switch, adjustable switch, remote control, smart phone, tablet, computer, smart watch, voice assistant, or other remote electronic device. The Controller Module can be external to the frame or concealed within the frame for a more self-contained solution. Each remote electronic device would have applicable software installed to provide the necessary user interface and integration with the Controller Module.

The invention can be fitted with lighting to match the décor in which it is installed or to provide additional ambiance and mood lighting. In one embodiment, LEDs or other decorative lighting is mounted on or from within the frame and powered by the same power source as the electronic film. The lighting can be one or a multiplicity of colors that is adjusted remotely using Wi-Fi, Bluetooth or a similar communication protocol in conjunction with a Controller Module and remote control, smart phone, tablet, computer, laptop, watch, voice assistant or other remote electronic device. Each remote electronic device would have applicable software installed to provide the necessary user interface and integration with the Controller Module.

The invention can also have its transparency controlled intelligently using input from sensor(s) and/or camera(s). In one embodiment, external sensor(s) and/or camera(s) can monitor light, temperature, motion and other surrounding conditions or triggers. In another embodiment, frame mounted sensor(s) and/or camera(s) can monitor light, temperature, motion and other surrounding conditions or triggers. Input from the sensor(s) and/or camera(s) in conjunction with a Controller Module and software can automatically adjust the electronic film transparency based upon pre-defined or learned conditions and expected results.

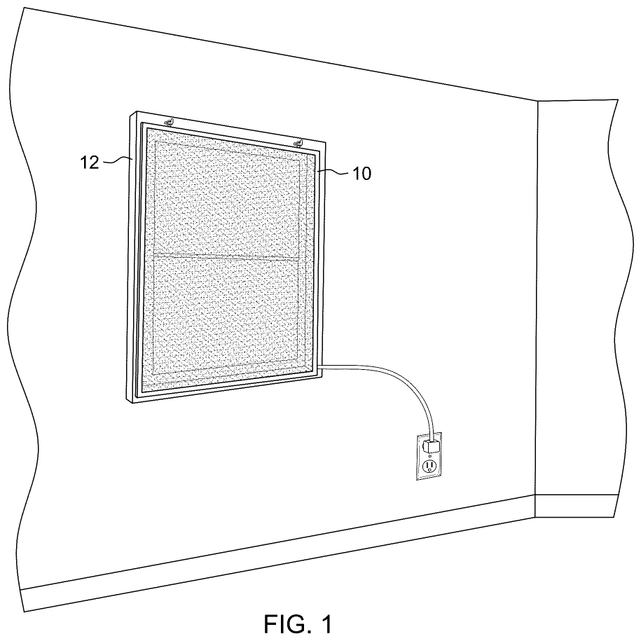

FIG. 1 depicts an electronic privacy shade 10 that can be mounted to a window casing 12 of a residential building window, commercial building window, RV window, automobile window, boat window, airplane window, partition wall, room divider, product and artwork unveiling, signage or anywhere visual privacy is required.

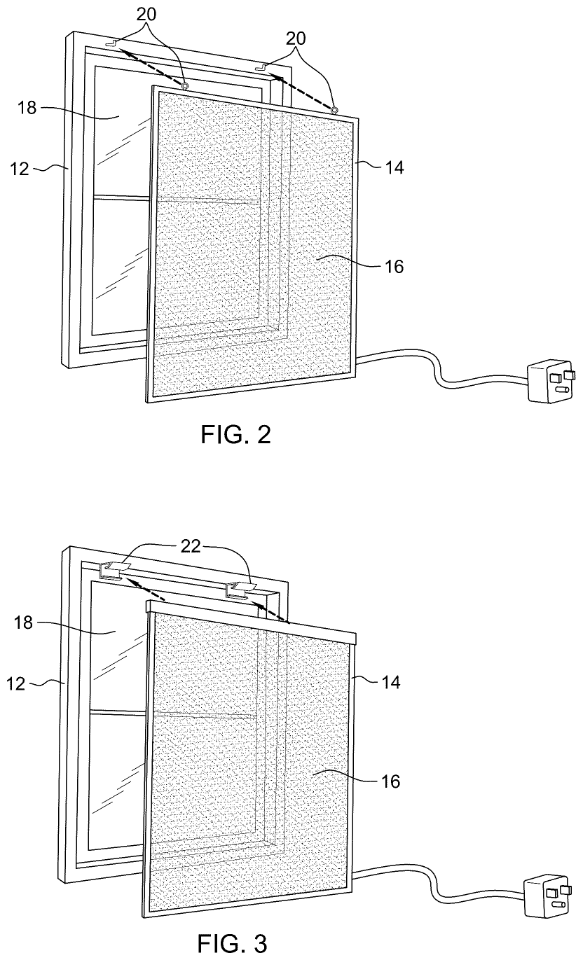

FIG. 2 depicts the privacy shade 10, wherein the privacy shade 10 is comprised of an electronic film 16, such as but not limited to Polymer Dispersed Liquid Crystal (PDLC), Suspended Particle Device (SPD), NanoChromics display (NCD), or Organic Electroluminescent Display (OELD), that is surrounded and supported by a frame 14 to conceal electrical circuitry and retain the needed shape and curvature. The electronic film 16 is made from, but not limited to, Polymer Dispersed Liquid Crystal (PDLC), Suspended Particle Device (SPD), Cholesteric Liquid Crystal (CLC), NanoChromics Display (NCD) or Organic Electroluminescent Display (OELD), whose transparency can be electronically controlled. The electronic film can come in a variety of colors that can be selected to match the environment in which it is placed. In one embodiment, a single piece of electronic film 16 is surrounded by a frame 14. The frame 14 supports the electronic film 16, provides the rigidity needed to maintain the intended shape, conceals electrical circuitry and allows the invention to be hung or mounted in a manner similar to a picture or blind. This eliminates the need for skilled installation that is associated with the adherence of electronic film 16 to existing glass surfaces. In another embodiment, multiple pieces of electronic film 16 are tiled and surrounded/supported by a frame 14. The transparency of each piece of electronic film 16 can be individually controlled for the desired effect. In another embodiment, the electronic film 16 is retracted around or lowered from a shade tube with hem bar for weight so that it can operate similar to a traditional roller shade for ease of removal.

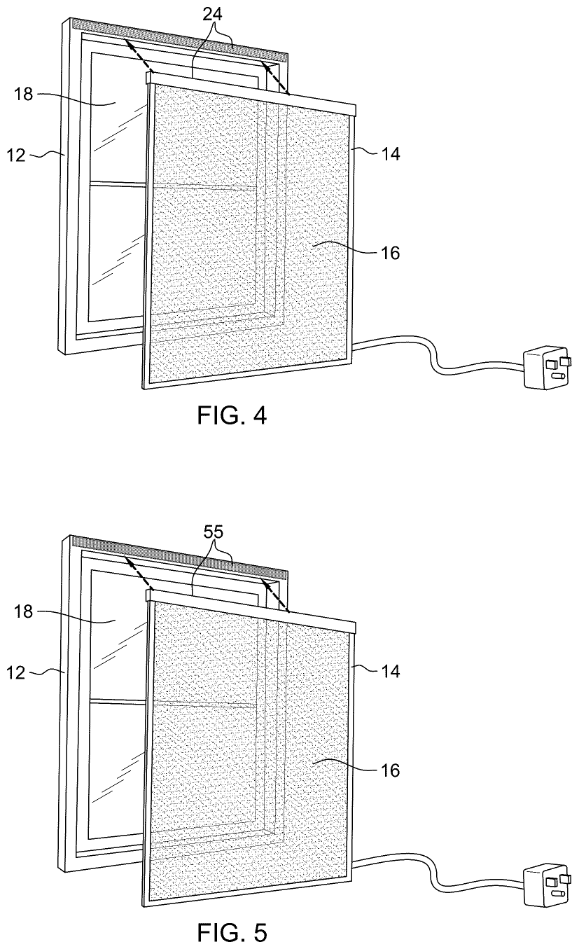

FIGS. 2-5 depict the privacy shade 10 mounted in various methods. The privacy shade 10 can be hung from a window casing 12 using hooks 20 to provide privacy from visibility through the window glass 18. In another embodiment, the privacy shade 10 can be held in place using clips or brackets 22. In another embodiment, the privacy shade 10 can be held in place using Hook and Loop or other kinds of tape 24 that would allow it to be placed in the desired location. In yet another embodiment, the privacy shade 10 can be held in place using magnets or magnetic tape 55 that would allow it to be placed in the desired location.

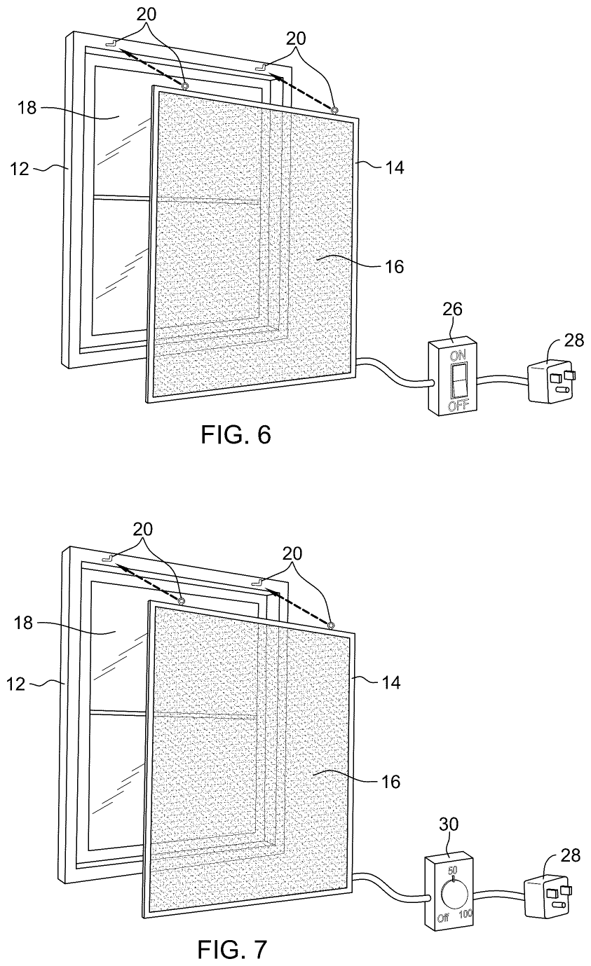

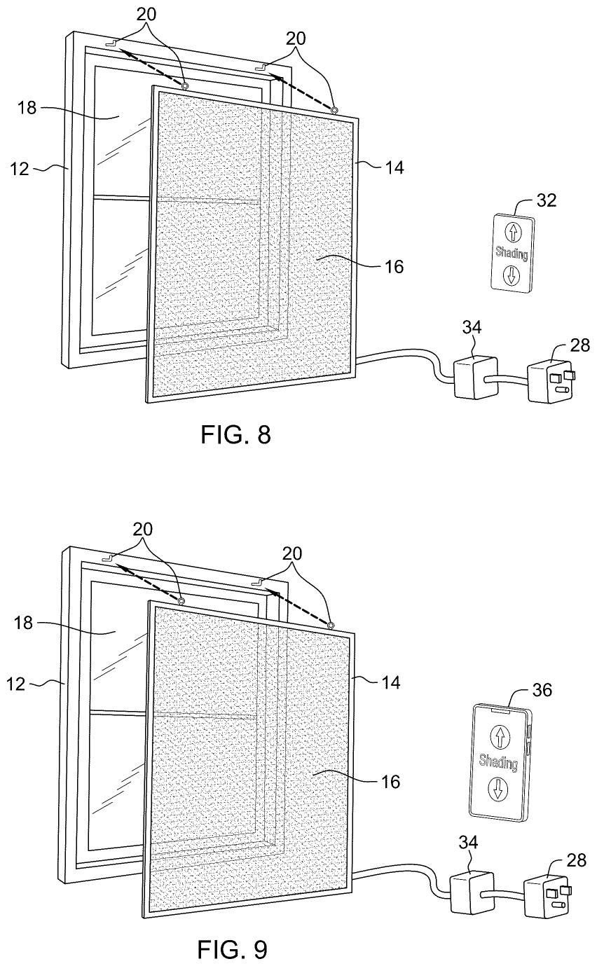

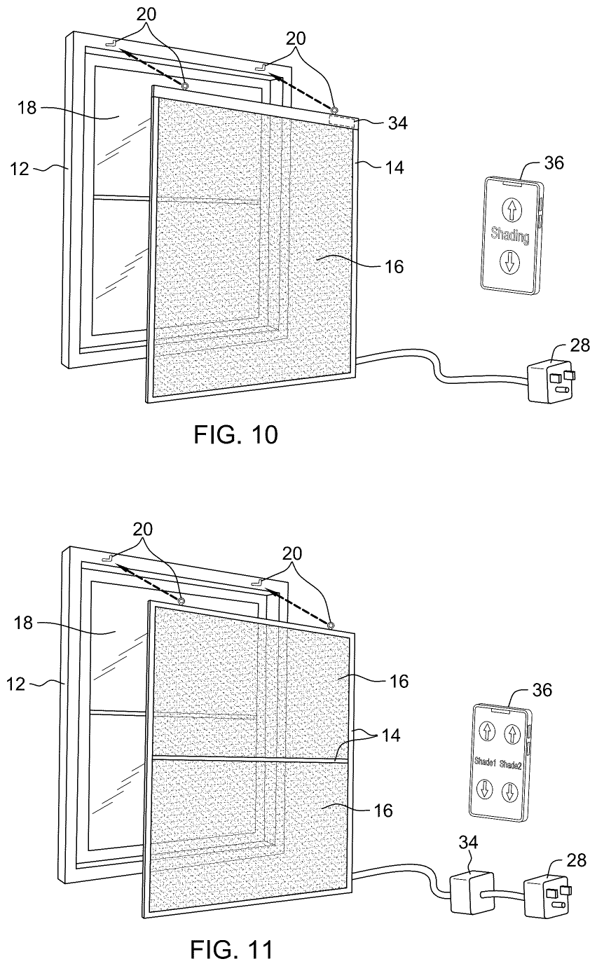

FIGS. 6-10 depict the privacy shade 10 with various features. The privacy shade 10 can be powered from a power adapter 28 that would be inserted into a power outlet. The electronic film 16 transparency can be turned on/off using a manual switch 26. This type of switch only provides full shading or no shading. In another embodiment, the privacy shade 10 can have the amount of electronic film 16 transparency controlled using a variable voltage regulator 30. In another embodiment, the privacy shade 10 can have the amount of electronic film 16 transparency controlled using a remote control 32 in conjunction with an integrated controller module 34 (as shown in FIG. 8). In yet another embodiment, the privacy shade 10 can have the amount of electronic film transparency controlled using an electronic device 36, such as but not limited to a smart phone, tablet, computer, smart watch, voice assistant or other similar device in conjunction with the integrated controller module 34 (as shown in FIG. 9). To reduce the number of external components, the integrated controller module 34 can be concealed within the frame 14.

FIG. 11 depicts the privacy shade 10 with two electronic films 16 in accordance with an embodiment. In another embodiment, a multiplicity of electronic films 16 can be tiled to provide privacy shading to specific regions of the privacy shade 10. Each electronic film 16 can be independently controlled by the electronic device 36 and the integrated controller module 34 can be external or can be concealed within the frame 14 as described above, along with a computing device, manual switch, adjustable switch, remote control, smart phone, tablet, computer, smart watch, voice assistant, or the like. In some embodiments, the privacy shade 10 has multiple integrated controller modules 34 that control each electronic films 16 independently. The multiple integrated controller modules 34 can also be contained within the frame 14.

In some embodiments, the integrated controller module 34 is able to independently control each piece of the privacy shade 10. The components of the integrated controller module 34 may include, but are not limited to, one or more processors or processing units, a system memory, and a bus that couples various system components including system memory to processor. A program or utility having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

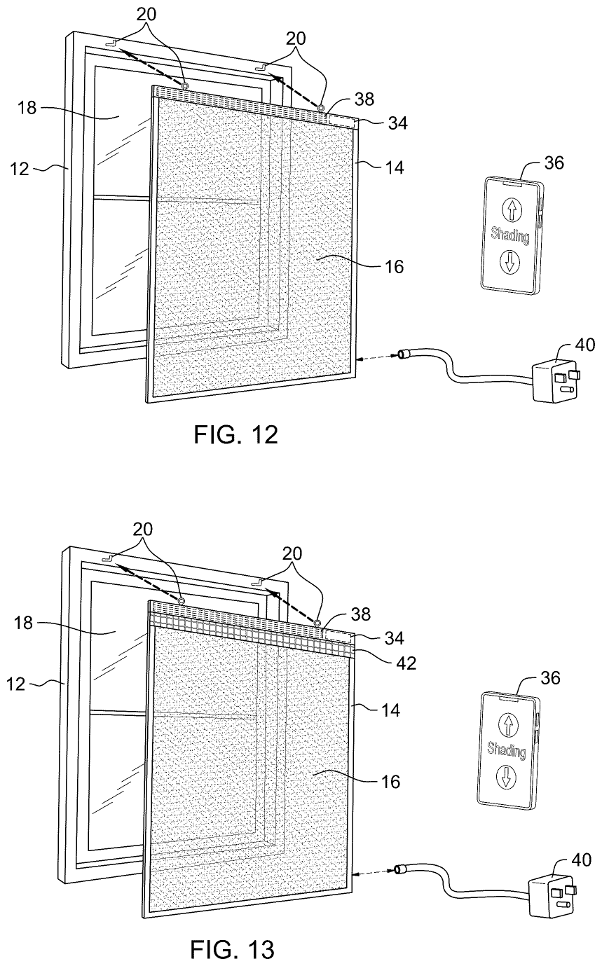

FIGS. 12 and 13 depict the privacy shade 10 with an integrated power source with a detachable power adapter 40 plugged into a power outlet in accordance with an embodiment. In another embodiment, the privacy shade 10 can be powered by disposable or rechargeable batteries 38 that are concealed within the frame. When rechargeable batteries are used, they can be recharged using the detachable power adapter 40 when needed. In another embodiment, the privacy shade 10 can also be powered by external or frame mounted solar panels 42, or other renewable power source. In yet another embodiment, the privacy shade 10 can be powered by rechargeable batteries 38 that are concealed within the frame and recharged using external or frame mounted solar panels 42, or other renewable power source.

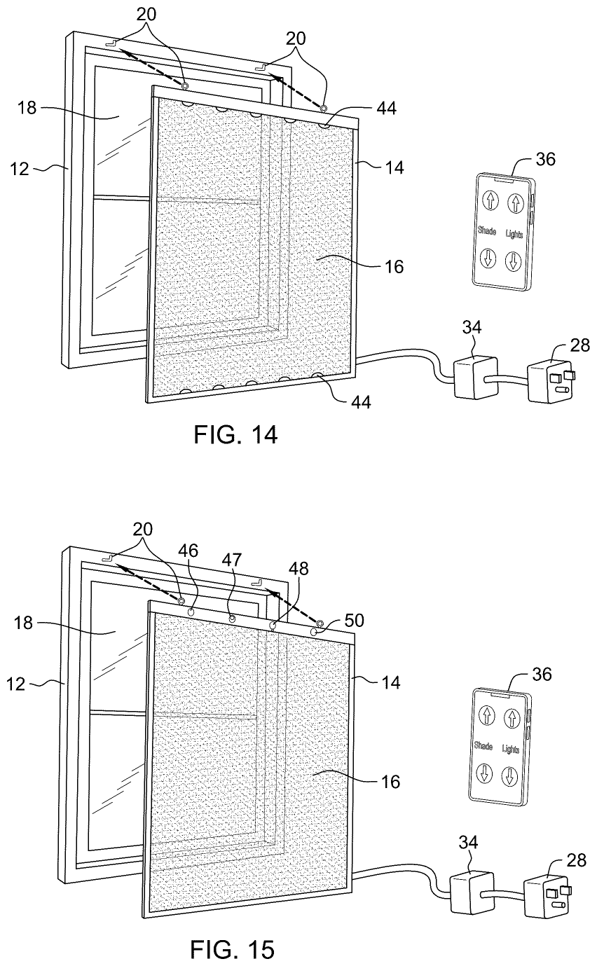

FIG. 14 depicts the privacy shade 10 fitted with lighting 44 that is embedded in or attached to the frame 14 of the privacy shade 10. The lighting can be one or a multiplicity of LEDs, or other such lighting, that in conjunction with the integrated controller module 34 can be operated using a computing device, manual switch, adjustable switch, remote control, smart phone, tablet, computer, smart watch, voice assistant or other similar electronic device 36.

FIG. 15 depicts the privacy shade 10 fitted with light sensor(s) 46, temperature sensor(s) 48, motion sensor(s) 50 and/or camera(s) 47 that are external, embedded in or attached to the frame 14 of the privacy shade 10. The sensors and cameras can be one or a multiplicity of devices that in conjunction with the integrated controller module 34 automatically control the amount of electronic film transparency based upon settings and thresholds configured by the user through an electronic device 36.

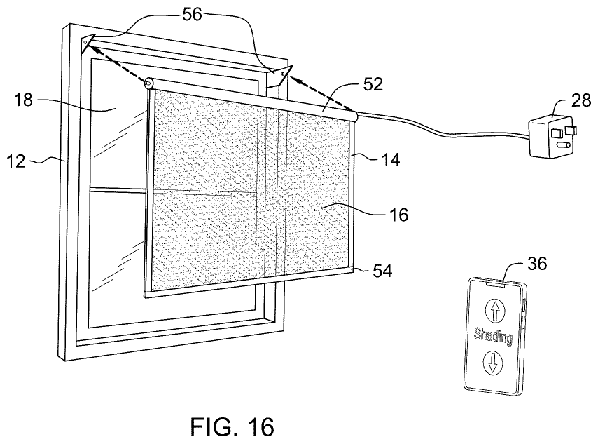

FIG. 16 depicts the privacy shade 10 with the electronic film 16 can be retracted around or lowered from a shade tube 52 with a hem bar 54 at the bottom for weight and stability. The current invention can be hung from a window casing 12 using brackets 56 to provide privacy from visibility through the window glass 18.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

It will be further understood that various changes in the details, materials, and arrangements of the parts which have been described and illustrated in order to explain the nature of this invention may be made by those skilled in the art without departing from the scope of the invention as expressed in the following claims.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g., attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A privacy shade, comprising:
a frame; and
an electronically controlled film secured within the frame.

2. The privacy shade of claim 1, further comprising, an integrated controller module.

3. The privacy shade of claim 2, further comprising, an electronic device, wherein the electronic device is able to communicate with the integrated controller module.

4. The privacy shade of claim 1, wherein, at least one additional electronically controlled film is secured by the frame.

5. The privacy shade of claim 1, further comprising a light emitting device integrated into the frame.

6. The privacy shade of claim 1, further comprising, a securement means integrated into the frame.

7. The privacy shade of claim 1, further comprising, a power source integrated into the frame and connected to the electronically controlled film.

8. The privacy shade of claim 1, further comprising a housing, wherein the housing is a shade tube attached to the frame.

9. A privacy shade, comprising:
a housing;
at least two electronically controlled films integrated with the housing; and
an integrated controller module in communication with the at least two electronically controlled films.

10. The privacy shade of claim 9, further comprising, a mounting system attached to the housing.

11. The privacy shade of claim 9, wherein each of the at least two electronically controlled films are independently controlled.

12. The privacy shade of claim 9, further comprising, at least one sensor integrated into the frame and connected with the integrated controller module, wherein the at least two electronically controlled films are adjusted based on data collected by the at least one sensor.

13. The privacy shade of claim 9, further comprising, at least one power source in communication with the integrated controller module.

14. The privacy shade of claim 9, where at least two electronically controlled films are made from a Polymer Dispersed Liquid Crystal (PDLC).

15. A privacy shade, comprising:
a frame;
a power source integrated into the frame;
an electronically controlled film secured to the frame and connected to the power source; and
a controller module in communication with the electronically controlled film and the power source.

16. The privacy shade of claim 15, further comprising, a shade tube attached to the electronically controlled film.

17. The privacy shade of claim 15, further comprising, a light source integrated into the shade tube and connected to the power source.

18. The privacy shade of claim 15, further comprising, a mounting system integrated into the shade tube and wherein a reciprocal mounting system is attached to a window.

19. The privacy shade of claim 15, having at least one sensor in communication with the controller module.

20. The privacy shade of claim 15, wherein the controller module is able to connect with an external computing device.
